(19) United States
(12) Patent Application Publication
(10) Pub. No.: US 2025/0328011 A1
(43) Pub. Date: Oct. 23, 2025

(54) HUD GUI VISIBILITY CHECK

(71) Applicant: Panasonic Automotive Systems Company of America, Division of Panasonic Corporation of North America, PEACHTREE CITY, GA (US)

(72) Inventor: SACHIKO KOBAYASHI, NOVI, MI (US)

(21) Appl. No.: 19/095,086

(22) Filed: Mar. 31, 2025

Related U.S. Application Data
(60) Provisional application No. 63/637,071, filed on Apr. 22, 2024.

(51) Int. Cl. G02B 27/01; B60K 35/235; B60K 35/26; B60K 35/28; G02B 27/00

(52) U.S. Cl. CPC G02B 27/0101; B60K 35/235; B60K 35/26; B60K 35/28; G02B 27/0093; B60K 2360/178; G02B 2027/0138; G02B 2027/014

(57) ABSTRACT

A head up display arrangement for a motor vehicle includes a picture generation unit emitting a light field along a projection path. At least one mirror is positioned to reflect the light field emitted by the picture generation unit such that the reflected light field is again reflected by a windshield of the motor vehicle so as to be visible by a human driver of the motor vehicle as a virtual image. A camera is positioned to capture images along the projection path. An electronic processor is communicatively coupled to the camera and analyzes the images captured by the camera to thereby determine whether there is an obstruction in the projection path. The electronic processor notifies the human driver of the obstruction if it is determined that there is an obstruction in the projection path.

### CROSS-REFERENCE TO RELATED APPLICATIONS

This application claims benefit of U.S. Provisional Application No. 63/637,071, filed on Apr. 22, 2024, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

A problem with current HUDs is that they do not know if the HUD graphical user interface (GUI) is being displayed on the windshield as long as there is no issue with the HUD hardware or software. So, the HUD system has to assume that all parts of the HUD GUI are being displayed as long as the HUD system is functioning. However, there are cases where an object, such as a piece of paper, can fall into the HUD glare trap and obstruct the HUD projection.

Without the ability to detect the obstruction between the HUD and the windshield or the damage on the windshield, the system does not know if the HUD GUI is being displayed properly. The driver may not even notice that part of the GUI/HUD information is missing due to blockage since there is no clear definition or format of the HUD “display” on the windshield that the driver normally sees. This can potentially lead to misinformation being conveyed to the driver while they drive. For example, object/pedestrian warnings, etc., can be blocked.

### SUMMARY

The present invention may provide an automotive system comprising a HUD with a camera integrated into it like an eye tracking camera but with object detection software that has an ability to detect any object or obstruction between the HUD and the windshield as well as to detect any obstruction in the form of damage on the windshield that can affect the effectiveness of the HUD.

The invention may detect any obstructions on the HUD LCD/glass within the glare trap or on the projection path between the HUD and the windshield such as a piece of paper that may block the projection of the HUD GUI (Graphical User Interface) on the windshield. The invention may also detect any damage on the windshield that may distort or disrupt the projection of the HUD GUI on the windshield. The invention may further detect and review the GUI displayed on the windshield to make sure all GUI elements are present and are displayed correctly on the windshield. If not, then the inventive system may notify the driver through the in-vehicle infotainment (IVI) system, the cluster, or through other means such as audible warning that the HUD GUI may not be displayed properly. In case the inventive system detects an obstruction, the system can instruct the driver to simply check the HUD glare trap and remove any obstruction without having to bring the vehicle into the dealership to diagnose the problem.

The invention may improve safety as more driver-critical information is displayed in the HUD if the system can detect any visual issue with the HUD GUI on the windshield. Depending on where the camera is placed, the system may also be used to confirm visibility of the HUD GUI at all times.

In case the windshield is replaced for any reason, the system can also confirm the HUD GUI is displayed fully and correctly on the windshield after the windshield is installed. The camera may also detect the environment and the weather and dynamically change the light intensity and GUI color to enhance the legibility and visibility of the HUD.

In one embodiment, the invention comprises a head up display arrangement for a motor vehicle including a picture generation unit emitting a light field along a projection path. At least one mirror is positioned to reflect the light field emitted by the picture generation unit such that the reflected light field is again reflected by a windshield of the motor vehicle so as to be visible by a human driver of the motor vehicle as a virtual image. A camera is positioned to capture images along the projection path. An electronic processor is communicatively coupled to the camera and analyzes the images captured by the camera to thereby determine whether there is an obstruction in the projection path. The electronic processor notifies the human driver of the obstruction if it is determined that there is an obstruction in the projection path.

In another embodiment, the invention comprises a method of operating a head up display for a motor vehicle, including emitting a light field along a projection path. The light field is reflected such that the reflected light field is again reflected by a windshield of the motor vehicle so as to be visible by a human driver of the motor vehicle as a virtual image. Images along the projection path are captured. The captured images are analyzed to thereby determine whether there is an obstruction in the projection path. The human driver is notified of the obstruction if it is determined that there is an obstruction in the projection path.

In yet another embodiment, the invention comprises a head up display arrangement for a motor vehicle including a picture generation unit emitting a light field along a projection path such that the light field is reflected by a windshield of the motor vehicle so as to be visible by a human driver of the motor vehicle as a virtual image. A camera is positioned to capture images along the projection path. An electronic processor is communicatively coupled to the camera and analyzes the images captured by the camera to thereby determine whether there is an obstruction in the projection path. The electronic processor notifies the human driver of the obstruction if it is determined that there is an obstruction in the projection path.

### BRIEF DESCRIPTION OF THE DRAWINGS

A better understanding of the present invention will be had upon reference to the following description in conjunction with the accompanying drawings.

FIG. 1 is a schematic diagram of one embodiment of a head up display and graphical user interface visibility checking arrangement of the present invention.

FIG. 2 is another schematic diagram of the head up display and graphical user interface visibility checking arrangement of FIG. 1.

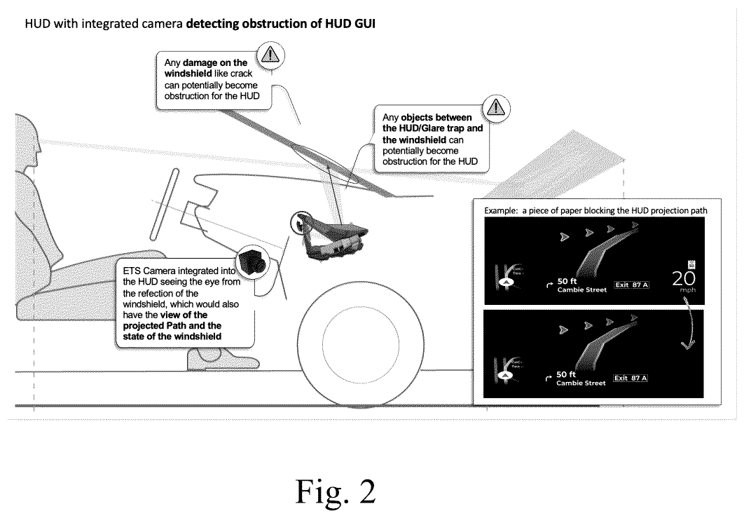

FIG. 3 is a flow chart of one embodiment of a method of the present invention for operating a head up display for a motor vehicle.

### DETAILED DESCRIPTION OF THE PREFERRED EMBODIMENTS

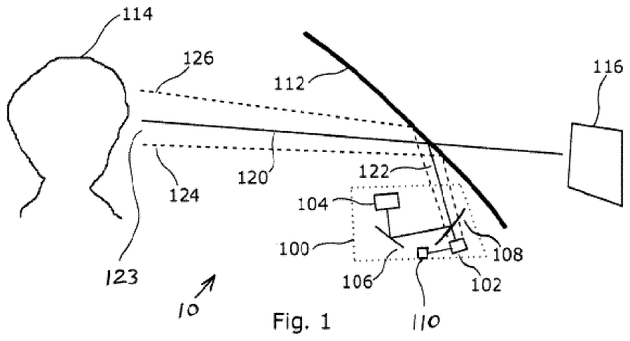

FIG. 1 illustrates one embodiment of a head up display (HUD) and graphical user interface visibility checking arrangement 10 of the present invention, including an eye tracking system (ETS) HUD (windshield type) 100 having an infrared (IR) energy transmitter/receiver and camera 102, a picture generation unit (PGU) 104, a fold mirror 106, a freeform (cold) mirror 108, and an electronic processor 110 that runs software to analyze the images captured by camera 102. Head up display (HUD) and eye tracking arrangement 10 further includes windshield 112.

Processor 110 may analyze the images captured by IR camera 102 to detect whether there are any obstructions along the projection path of PGU 104 and to detect whether there are any cracks or other damage to windshield 112. Processor 110 may also analyze the images captured by IR camera 102 to detect the position of the head or eyes of a human driver 114 in the images.

FIG. 1 shows a schematic of a traditional ETS HUD (windshield type) 100, with the ETS camera of IR part 102 on the optical axis and multiple IR illuminators of IR part 102 disposed around the camera. The emission from different IR illuminators on the same IR part 102, especially the axial ray, joins the visible axial light ray from picture generation unit (PGU) 104 and fold mirror 106 at the freeform (cold) mirror 108. The visible light is reflected by different areas on mirror 108 and, along with the IR energy that transmits through mirror 108, is subsequently reflected by windshield 112 toward human driver 114. The visible light and IR energy eventually reach the driver 114, and thus the driver can see a virtual image 116 that appears to be outside of windshield 112 ahead of the vehicle. The axial rays 120, 122 that start from the center of eye box 123 reach the center of the IR camera of IR part 102. The rays 124 and 126 represent some edge rays or outermost rays from the driver's face that can be seen by the IR camera of IR part 102.

During use, processor 110 may analyze the images captured by camera 102 to thereby detect some condition that prevents user 114 from seeing virtual image 116, such as a crack in windshield 112, or a piece of paper or other object or obstruction blocking the light field projected by PGU 104. The light field may be within a projection path bounded by rays 124 and 126. If processor 110 does detect such a condition, then processor 110 may alert user 114 that the HUD requires some repair, maintenance or decluttering. The alert may be in the form of a visible message within virtual image 116, an audio message played by loudspeakers (not shown) within the vehicle, or a visible message on a display screen (not shown) of the vehicle, for example.

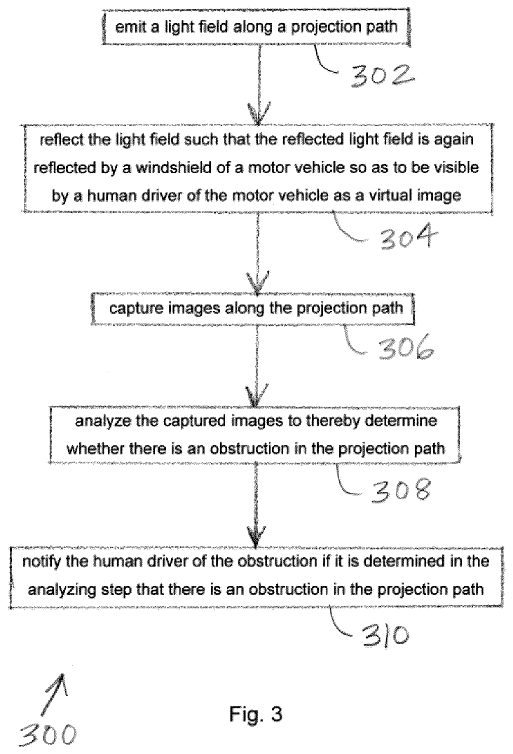

FIG. 3 illustrates one embodiment of a method 300 of the present invention for operating a head up display for a motor vehicle. In a first step 302, a light field is emitted along a projection path. For example, PGU 104 may project a light field within a projection path bounded by rays 124 and 126.

Next, in step 304, the light field is reflected such that the reflected light field is again reflected by a windshield of the motor vehicle so as to be visible by a human driver of the motor vehicle as a virtual image. For example, the light field is reflected by mirrors 106, 108 such that the reflected light field is again reflected by a windshield 112 of the motor vehicle so as to be visible by a human driver 114 of the motor vehicle as a virtual image 116.

In a next step 306, images are captured along the projection path. For example, the IR camera of IR part 102 may capture images along the projection path bounded by rays 124 and 126.

In step 308, the captured images are analyzed to thereby determine whether there is an obstruction in the projection path. For example, processor 110 may analyze the images captured by camera 102 to thereby detect a piece of paper or other object or obstruction blocking the light field projected by PGU 104.

In a final step 310, the human driver is notified of the obstruction if it is determined in the analyzing step that there is an obstruction in the projection path. For example, processor 110 may alert user 114 that the HUD requires some decluttering. The alert may be in the form of a visible message within virtual image 116, an audio message played by loudspeakers (not shown) within the vehicle, or a visible message on a display screen (not shown) of the vehicle.

The invention has been described as including an IR camera, however, it is to be understood that the invention can also be implemented with a conventional visible light camera. The conventional camera may view the optical path through a transparent section or through hole in mirror 108. Else, the conventional camera may be mounted coaxially with PGU 104, such as in the same housing as PGU 104, to thereby view the optical path of PGU 104.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
a picture generation unit configured to emit a light field along a projection path;
at least one mirror positioned and configured to reflect the light field emitted by the picture generation unit such that the reflected light field is again reflected by a windshield of the motor vehicle so as to be visible by a human driver of the motor vehicle as a virtual image;
a camera positioned and configured to capture images along the projection path; and
an electronic processor communicatively coupled to the camera and configured to:
analyze the images captured by the camera to thereby determine whether there is an obstruction in the projection path; and
notify the human driver of the obstruction if it is determined that there is an obstruction in the projection path.

2. The head up display arrangement of claim 1 wherein the obstruction in the projection path comprises an object.

3. The head up display arrangement of claim 1 wherein the obstruction in the projection path comprises a crack in the windshield.

4. The head up display arrangement of claim 1 wherein the camera comprises an infrared, eye-tracking camera.

5. The head up display arrangement of claim 1 wherein the camera comprises a visible light camera.

6. The head up display arrangement of claim 1 wherein the electronic processor is configured to notify the human driver of the obstruction by displaying a message.

7. The head up display arrangement of claim 1 wherein the electronic processor is configured to notify the human driver of the obstruction by presenting an audible message on a loudspeaker.

8. A method of operating a head up display for a motor vehicle, the method comprising:
emitting a light field along a projection path;
reflecting the light field such that the reflected light field is again reflected by a windshield of the motor vehicle so as to be visible by a human driver of the motor vehicle as a virtual image;
capturing images along the projection path;
analyzing the captured images to thereby determine whether there is an obstruction in the projection path; and
notifying the human driver of the obstruction if it is determined in the analyzing step that there is an obstruction in the projection path.

9. The method of claim 8 wherein the obstruction in the projection path comprises an object.

10. The method of claim 8 wherein the obstruction in the projection path comprises a crack in the windshield.

11. The method of claim 8 wherein the images are captured by an infrared, eye-tracking camera.

12. The method of claim 8 wherein the images are captured by a visible light camera.

13. The method of claim 8 wherein the notifying step comprises displaying a message.

14. The method of claim 8 wherein the notifying step comprises presenting an audible message on a loudspeaker.

15. A head up display arrangement for a motor vehicle, the arrangement comprising:
a picture generation unit configured to emit a light field along a projection path such that the light field is reflected by a windshield of the motor vehicle so as to be visible by a human driver of the motor vehicle as a virtual image;
a camera positioned and configured to capture images along the projection path; and
an electronic processor communicatively coupled to the camera and configured to:
analyze the images captured by the camera to thereby determine whether there is an obstruction in the projection path; and
notify the human driver of the obstruction if it is determined that there is an obstruction in the projection path.

16. The head up display arrangement of claim 15 wherein the obstruction in the projection path comprises an object.

17. The head up display arrangement of claim 15 wherein the obstruction in the projection path comprises a crack in the windshield.

18. The head up display arrangement of claim 15 wherein the camera comprises an infrared, eye-tracking camera.

19. The head up display arrangement of claim 15 wherein the camera comprises a visible light camera.

20. The head up display arrangement of claim 15 wherein the electronic processor is configured to notify the human driver of the obstruction by displaying a message and/or presenting an audible message on a loudspeaker.
